(19) United States
(12) Patent Application Publication
(10) Pub. No.: US 2014/0330589 A1
(43) Pub. Date: Nov. 6, 2014

(54) DYNAMIC MEDICAL INFORMATION MODEL FOR COORDINATED PATIENT CARE DELIVERY

(71) Applicant: Zoeticx Inc., San Jose, CA (US)

(72) Inventors: Thanh H. Tran, San Jose, CA (US); Alon Segal, Herzlia (IL)

(21) Appl. No.: 14/366,328

(22) PCT Filed: Jan. 14, 2013
(86) PCT No.: PCT/IB13/50343

§ 371 Date: Jun. 18, 2014

Related U.S. Application Data
(60) Provisional application No. 61/587,110, filed on Jan. 16, 2012.

(51) Int. Cl. G06F 19/00

(52) U.S. Cl. CPC G06F 19/322
USPC 705/3

(57) ABSTRACT

The methods and systems described by the present invention enable managing a medical order provided to a patient, comprising:
a) Receive a medical order provided to a patient that defines a plurality of medical activities to be performed in a predefined order.
b) Automatically create a list of a plurality of tasks for each medical activity, each task is assigned with a tracking status.
c) Automatically associate each task with at least one of a plurality of care providers.
d) Automatically notify the at least one care provider using a client terminal about the respective associated task.
e) Aggregate a plurality of input messages each indicative of a status of one of the tasks.
f) Automatically update the tracking status according to the input messages during the period of the medical order.
g) Outputting a dataset of the medical order which is indicative of the tracking status for each task.

### BACKGROUND

The present invention, in some embodiments thereof, relates to managing a medical order related to a treatment provided to a patient, and, more specifically, but not exclusively, to managing a medical order through an automated closed loop and real time system that assures correct workflow of a medical order, associates the medical order activities with relevant care providers, tracks progress of the workflow of the medical order, notifies and alerts the relevant care providers and logs the workflow of the medical order.

Patient care in a controlled environment in which a series of events is initiated, managed and monitored by attending care providers. As patient care services and institutes are becoming more distributed and complex, many care provider entities, for example physicians, nurses, medical institutes, laboratories and/or imaging facilities are involved in the workflow of medical orders relating to a treatment provided to a single patient. This distributed environment requires the workflow of the medical order to be controlled, efficient and near real time in order to avoid lack of synchronization between a plurality of care providers, avoid redundancies, enable remote monitoring of the patient's condition, keep track of the medical order progress and medical activities status, associate a relevant care provider with the medical activities, alert the relevant care provider of a breach in the workflow of the medical order or other predefined events and maintain a log for the medical order workflow. A breach in the workflow of the medical order may be for example, failure to perform tasks in a predefined order failure to perform one or more tasks and/or cancellation of one or more of the tasks by a care provider.

Reference is now made to FIG. 1, which is a schematic illustration of a workflow of an exemplary medical order. One or more care of the providers may initiate a medical order that relates to a treatment provided to the patient. The medical order may include a plurality of medical activities that are required by the medical order. Each of the plurality of medical activities is not a workflow by itself but rather a specific contained activity that needs to be performed as part of the workflow of the medical order. The plurality of medical activities may each include a plurality of tasks that are part of the medical activity. Each of the plurality of tasks may be assigned to one or more of the medical care providers. The plurality of tasks that are associated with each of the one or more medical activities are performed with respect to the patient. The results of the plurality of tasks may be reported back to the one or more of the care providers.

Traditionally, the medical order is initiated manually by the one or more of the care providers after examining the patient and generating a hard copy medical record that includes the medical activities that need to be performed. Other care providers may be involved with the medical activities associated with the medical order. The medical order and its related medical activities are managed and monitored through the patient's medical record which is also used for logging the medical order. The medical order may be modified by an accountable care provider attending to the patient in person. As technology advances, the medical record may be available in electronic format, electronic medical record (EMR) replacing the hard copy record.

The patient medical record both in hard copy and in electronic form fails to provide an efficient controlled, closed loop system due to the complex and distributed patient care environment. The patient medical record is susceptible to various flaws, for example, different care providers issuing conflicting and/or redundant orders, inability to provide real time information on the medical activities status and/or on the patient's condition, inability to alert a relevant care provider in the event of an emergency or a failure to perform the medical order, etc.

### SUMMARY

According to some embodiments of the present invention, there are provided systems and methods for managing a plurality of medical orders associated with treatments provided to a plurality of patients. Managing the plurality of medical orders enables a tightly controlled, patient centric, closed loop and near real time workflow for a plurality of medical orders that are part of a treatment provided to a plurality of patients. One or more of a plurality of care providers may issue the medical order relating to a treatment provided to one of the plurality of patients. The medical order is received and a list of one or more medical activities is automatically generated according to a pre-defined template that details the medical activities that are required with respect to the medical order. Each of the plurality of medical activities is not a workflow by itself but rather a specific contained activity that needs to be performed as part of the workflow of the medical order. Each of the required medical activities is further divided to a plurality of singular tasks and a tasks list is automatically generated according to a pre-defined template that details the tasks that are required with respect to each medical activity. Each of the plurality of tasks is assigned with a tracking status and each of the plurality of tasks is associated with one or more of the care providers. The tracking status may include a plurality of condition rules that may be used for alerting one or more of the care providers. A notification message containing the tasks(s) information is transmitted to the one or more of the care providers using a plurality of client terminals for example desktop, laptop, tablet, phone and/or beeper. The notification message may be sent using one or more networks, for example, wireless, cellular and/or internet. During the period from issuing the medical order and to the completion of the medical order, input messages are received indicating the status of each of the plurality of tasks. Each of the plurality of tasks is tracked and the tracking status of each of the plurality of tasks is updated according to the received input messages. Alerts may be generated and transmitted to the one or more of the care providers using the plurality of client terminals, according to the progress of the plurality of tasks. The workflow of the medical order is recorded and a log is generated to reflect the plurality of tasks progress.

Optionally, monitoring information is collected from one or more of a plurality of medical monitoring instruments capable of transmitting data over the one or more networks.

More optionally, monitoring information is collected over the one or more networks from one or more care providers using the plurality of client terminals.

More optionally, monitoring information is collected over the one or more networks from the patient using the plurality of client terminals.

More optionally, monitoring information is available to one or of the care providers using the plurality of client terminals.

More optionally, monitoring information is recorded in the log of the medical order.

More optionally an alert message is transmitted to one or more of the plurality of care providers in case a condition rule is fulfilled.

More optionally, one or more of a plurality of medical records databases is accessed to retrieve medical history of the patient to be used during the period of the medical order. The plurality of medical records databases may be available in a plurality of different formats and/or storage systems. Retrieved data from one or more medical records databases may be synchronized to provide a comprehensive, detailed and up to date description of the patient medical history.

More optionally, the medical history of the patient is available to one or more of the care providers using the plurality of client terminals.

More optionally, the status of the plurality of tasks is available to one or more of the care providers using the plurality of client terminals.

More optionally, the monitoring information of the patient is available to one or more of the care providers using the plurality of client terminals.

More optionally, one or more of a plurality of resource management system of the care providers is accessed to retrieve availability information of one or more of the care providers. Availability information may include for example, expertise, care provider ranking and/or, location of treatment.

More optionally, the availability information is used to identify an accountable care provider that is available and suitable for performing a certain task of the plurality of tasks and the accountable care provider is notified of the task information.

More optionally, the availability information is used to identify and alert an accountable care provider that is available to receive a certain alert of a plurality of alerts that includes alert condition information.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a workflow of an exemplary medical order;

FIG. 2 is a schematic illustration of an exemplary management system for a medical order and entities the system is interacting with, according to some embodiments of the present invention;

FIG. 3 is a flowchart of an exemplary process for managing a medical order, according to some embodiments of the present invention;

FIG. 4 is a schematic illustration presenting notifications and alerts associated with an exemplary medical order work flow, according to some embodiment of the present invention;

FIG. 5 is a schematic illustration of modules contained in an exemplary system for managing a medical order, according to some embodiment of the present invention; and

FIG. 6 is a schematic illustration of a workflow of a medical order in an exemplary medical environment implementing a system for managing a medical order, according to some embodiment of the present invention.

### DETAILED DESCRIPTION

According to some embodiments of the present invention, there are provided systems and methods for managing a plurality of medical orders associated with treatments and/or procedures provided to a plurality of patients. A medical order is received from one or more of a plurality of care providers, and a list of one or more medical activities is automatically generated. The medical activities list is generated using a pre-defined template that describes medical activities that are associated with the medical order. Each of the one or more medical activities is not a workflow by itself but rather a specific contained activity that needs to be performed as part of the workflow of the medical order. A tasks list is generated for each of the one or more of the medical activities, where the tasks list includes a plurality of singular tasks required for the medical activity. The tasks list is automatically generated according to a pre-defined template. A tracking status is assigned to each of the plurality of tasks and each task of the plurality of tasks is associated with one or more of the care providers. A notification message is transmitted to the associated one or more of the care providers using a plurality of client terminals for example desktop, laptop, tablet, phone and/or beeper. The notification message includes the associated task(s) information. The notification message may be sent using one or more networks, for example, wireless, cellular and/or internet. Input messages are received during the period from issuing the medical order to the completion of the medical order, where the input messages indicate the status of each of the plurality of tasks. Completion of the medical order may be for example, completion of all tasks, cancellation of medical order, postponement of the medical order, cancellation of remaining unperformed one or more of the plurality of tasks associated with the medical order and/or postponement of remaining unperformed one or more of the plurality of tasks associated with the medical order. The tracking status of each of the plurality of tasks is updated according to the received input messages. Alert may be generated and alert message may be transmitted to an accountable one or more of the care providers according to the progress of the plurality of tasks. The workflow of the medical order is recorded and a log is generated to reflect the plurality of tasks progress.

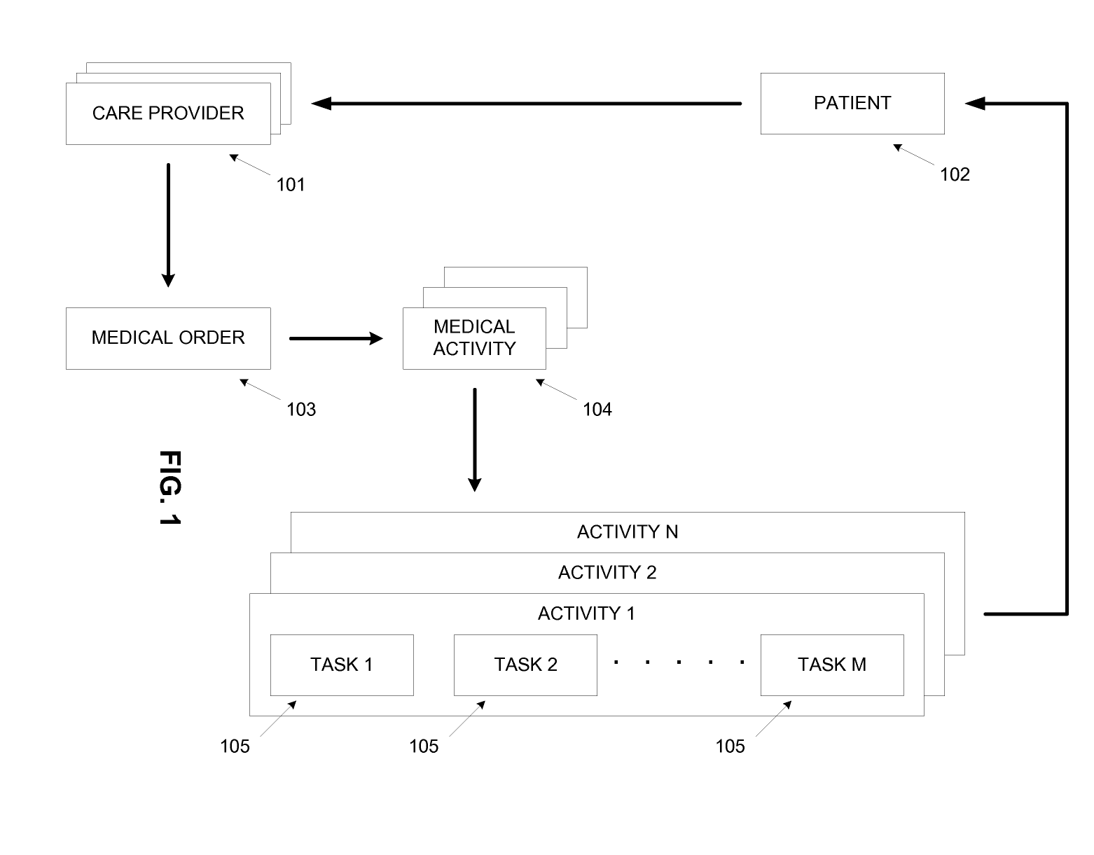

Reference is now made, once again, to FIG. 1. Managing the medical order 103 involves interaction with a plurality of entities. A plurality of care providers 101 may be responsible for performing the required actions to complete the medical order 103, for example, medical personnel, medical facilities and/or other medical and non-medical resources. As a plurality of patients are provided with treatment at any given time, managing and monitoring of the medical orders is crucial.

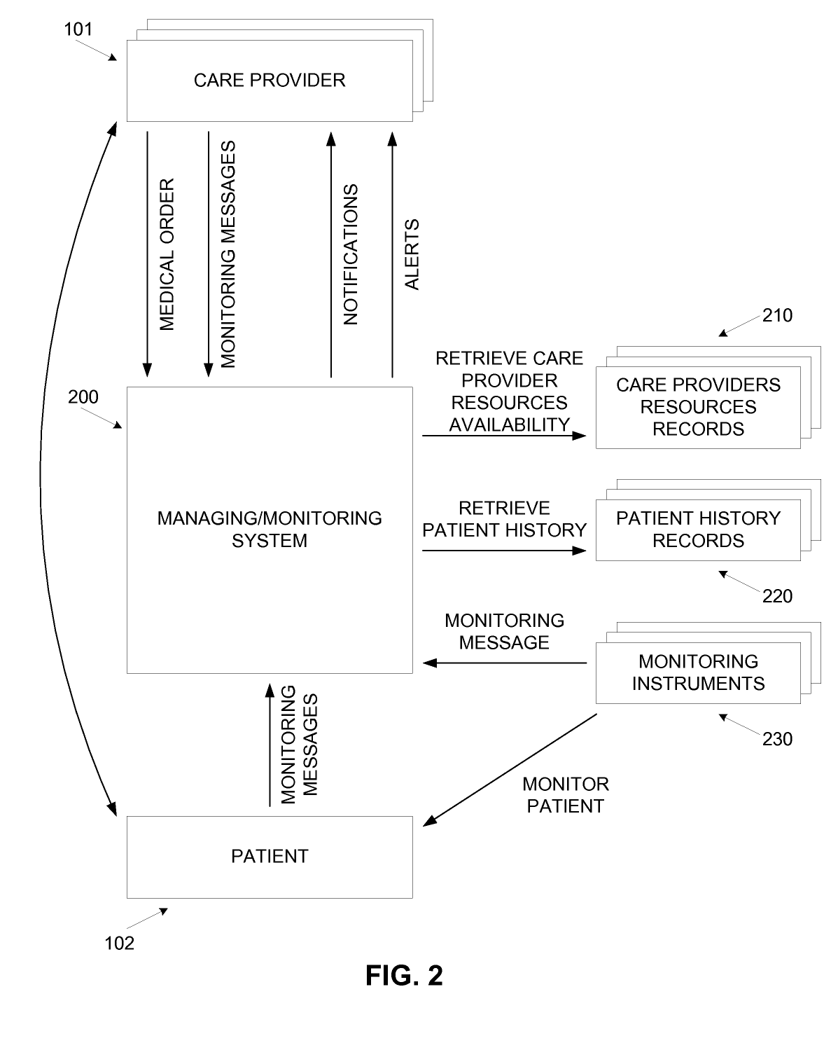

Reference is now made to FIG. 2 which is a schematic illustration of an exemplary management system for a plurality of medical orders 103 and entities the system is interacting with, according to some embodiment of the present invention. A system 200 includes a processing unit that executes one or more software modules for managing and monitoring a plurality of medical orders 103, for example, personal computer, server, and/or a distributed processing system that includes a plurality of processing nodes. The system 200 interacts with one or more of the plurality of care providers 101 using the plurality of client terminals for receiving the medical order 103 which is a part of a treatment provided to the patient 102. The system 200 transmits notification and alert messages to one or more of the care providers 101 using the plurality of client terminals over the one or more networks. The notification and alert messages are transmitted according to a plurality of rules, for example, availability of the care providers 101, contact method of the care providers 101, patient condition and/or progress of the medical order 103.

Optionally, the system 200 receives monitoring information of the condition of the patient 102 from a plurality of medical monitoring instruments 230 that are monitoring the patient 102 and are capable of transmitting monitoring information using the one or more networks.

More optionally, the system 200 receives monitoring information of the condition of the patient 102 from a plurality of the care providers 101 using the plurality of client terminals over the one or more networks.

More optionally, the system 200 receives monitoring information of the condition of the patient 102 from the patient 102 using the plurality of client terminals over the one or more networks.

More optionally, the system 200 accesses one or more resources records 210 of the care providers 101 to retrieve information on one or more service providers 101.

More optionally, the system 200 accesses one or more patient history records 220 of the patient 102 to retrieve information on medical history of the patient 102. The plurality of medical records databases 220 may be available in a plurality of different formats and/or storage systems. Retrieved data from one or more medical records databases may be synchronized to provide a comprehensive, detailed and up to date description of the patient medical history.

More optionally, the patient medical records 220 include a plurality of EMR systems.

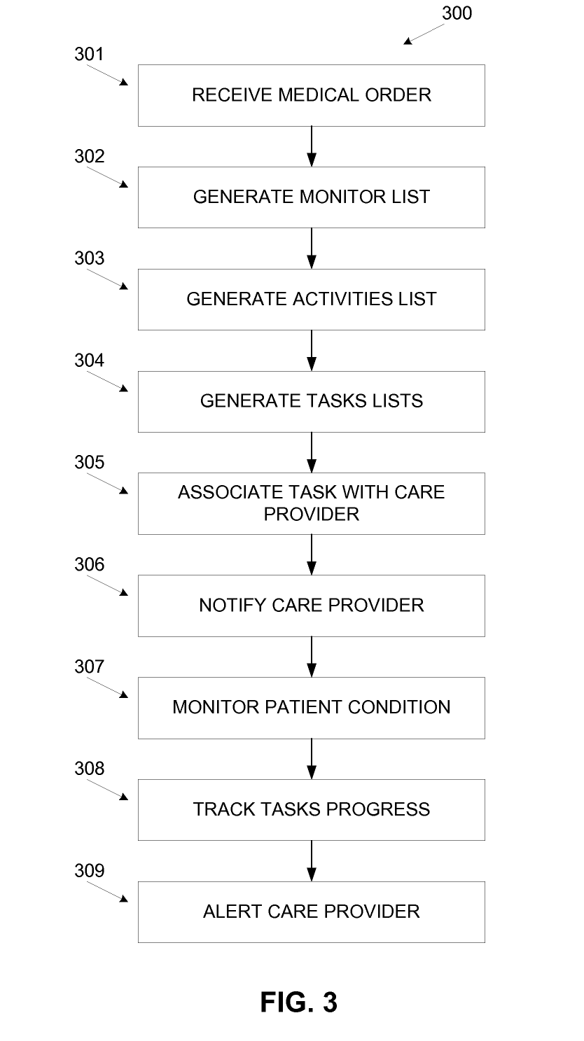

Reference is now made to FIG. 3 which is a flowchart of an exemplary process for managing a medical order, according to some embodiment of the present invention. As shown at 301, a process 300 for managing the medical order 103 is started by receiving the medical order 103 issued by one or more of the care providers 101 using the plurality of client terminals.

As shown at 302, the received medical order 103 is processed and a monitor list may be generated that includes required monitoring information of the patient 102 and/or a plurality of monitor rules. The monitor list is generated automatically according to a pre-defined template that includes the monitoring parameters required for the medical order 103, for example, blood pressure, blood count and/or heart beat. The monitor rules may describe the required monitoring information with respect to the patient 102, for example, blood pressure range, blood count range and/or heart beat range that in case of deviation from the specified range, an alert message is transmitted.

Optionally, the monitor list is modified by one or more of the care providers 101 according to the condition of the patient 102.

More optionally, the monitor list is automatically modified according to the medical history of the patient 102 that is retrieved from the patient history records 220.

More optionally, the each one of the plurality of monitor rules has an escalation field to handle escalation in the condition of the patient 102. The escalation field specifies two or more of the care providers 101, each of the two or more of the care providers 101 is associated with a different level of criticality of the monitoring information. This is done to assure raising the attention of the accountable one or more of the care providers 101 of an escalation in the condition of the patient 102 and to verify a proper and timely action is taken with respect to the patient 102.

As shown at 303, the received medical order 103 is processed and an activities list is generated which describes the medical activities 104 that need to be performed in order to carry out the medical order 103. The activities list is generated automatically according to a pre-defined template that includes the medical activities 104 that are required for the medical order 103.

Optionally, the activities list is modified by one or more of the care providers 101 according to the condition of the patient 102.

More optionally, the activities list is automatically modified according to the medical history of the patient 102 that is retrieved from the patient history records 220.

As shown at 304, the activities list is further divided to one or more tasks lists comprising a plurality of singular tasks 105 required by each activity 104. The tasks lists are generated automatically according to a pre-defined template that includes the tasks 105 that are required for the corresponding activity 104. Each of the tasks 105 is assigned with a tracking status to allow the system 200 to track the task's progress.

Optionally, the tracking status for each task 105 includes a plurality of condition rules which include conditions for alerting one or more of the care providers 101 with regard to the task 105.

More optionally, the tracking status for each task 105 has an escalation filed in which at least two of the care providers 101 may be specified, each associated with a different level of criticality and/or urgency of the status of the task 105 with respect to the patient 102. This is done to assure raising the attention of a higher ranking accountable one or more of the care providers 101 to the progress of the plurality of tasks 105 associated with the medical order 103. An escalation situation may be preconfigured in the plurality of task condition rules and may include for example, failure to complete one or more tasks within a predefined time period, failure to report on the progress of one or more tasks and/or failure to perform tasks in predefined order.

As shown at 305, each task 105 is associated with one or more of the care providers 101. Association of each of the plurality of tasks 105 to the one or more of the care providers 101 is done according to a pre-defined list of the care providers 101.

Optionally, association of the task 105 to the one or more of the care providers 101 is done dynamically by accessing the resources records 210 and identifying a one or more of the care providers 101 that are currently available. Availability may constitute of a plurality of parameters, for example, expertise, responsibility and/or location. Contact information for the accountable one or more of the care providers 101 may be retrieved from the resources records 210, for example, phone number, internet protocol (IP) address and/or email address.

As shown at 306, a notification message for every task 105 is sent over the one or more networks to each one or more of the care providers 101 that is associated with the task 105. The notification message is a push message in nature, meaning the notification message is automatically transmitted to the one or more of the care providers 101 using the plurality of client terminals with no need for the one or more of the care providers 101 to initiate a query on standing notification messages.

Optionally, the notification message is persistent according to task 105 progress, retransmitting the notification message to the one or more of the care providers 101 according to preconfigured settings, for example, at predefined intervals, at task start, at task completion, cancellation of task by one or more of the care providers 101, at modification of task by one or more of the care providers 101, at identification of failure during task execution, at identification of failure to complete task within a predefined time period, according to task progress, and/or at completion of medical activity and/or medical order.

As shown at 307, monitoring information of the condition of the patient 102 may be collected and made available to care providers 101. As aforementioned the monitoring information may be received from a plurality of medical monitoring instruments 230 capable of transmitting monitoring information, from a plurality of care providers 101 using the plurality of client terminals and/or from the patient 102 using the plurality of client terminal. Monitoring information is received using the one or more networks.

As shown at 308, each of the tasks 105 relating to each of the medical activities 104 of the medical order 103 is continuously tracked. Care providers 101 using the plurality of client terminal send over the one or more networks, task progress information for the tasks 105 they are assigned with. The task progress information is used for tracking the plurality of tasks 105.

Optionally, tasks 105 tracking information and progress status is available to the care providers 101.

As shown at 309, an alert may be transmitted over the one or more networks to one or more of the care providers 101 using the plurality of client terminals to indicate a plurality of events as defined by the task rules. Task rules may include, for example, start of task, completion of a task, incompletion of a task within a predefined time period, incompletion of task by the time the patient 102 is discharged, escalation in tasks execution, etc. The alert message is of push message in nature, meaning the alert message is automatically transmitted to the one or more of the care providers 101 using the plurality of client terminals with no need for the one or more of the care providers 101 to initiate a query on standing alert messages.

Optionally, an alert is transmitted to one or more of the care providers 101 at the event of a condition of one or more of the plurality of monitor rules is fulfilled for example, escalation in the condition of the patient 102.

More optionally, the alert message is persistent according to the progress of the task 105, retransmitting the alert message to the one or more of the care providers 101 according to preconfigured settings, for example, at predefined intervals, at task start, at task completion, at cancellation of task by one or more of the care providers 101, at modification of task by one or more of the care providers 101, at identification of failure during task execution, at identification of failure to complete task within a predefined time period, according to task progress and/or at completion of medical activity and/or medical order.

The workflow of the medical order 103 is continuously tracked and monitoring information is collected until the medical order completes. Completion of the medical order 103 may be decided by the accountable one or more of the care providers 101 and may be based on several parameters, for example, completion, addition, repetition and/or cancellation of medical activities 104 and their related tasks 105 that are required by the medical order 103 and/or termination and/or postponement of the medical order 103.

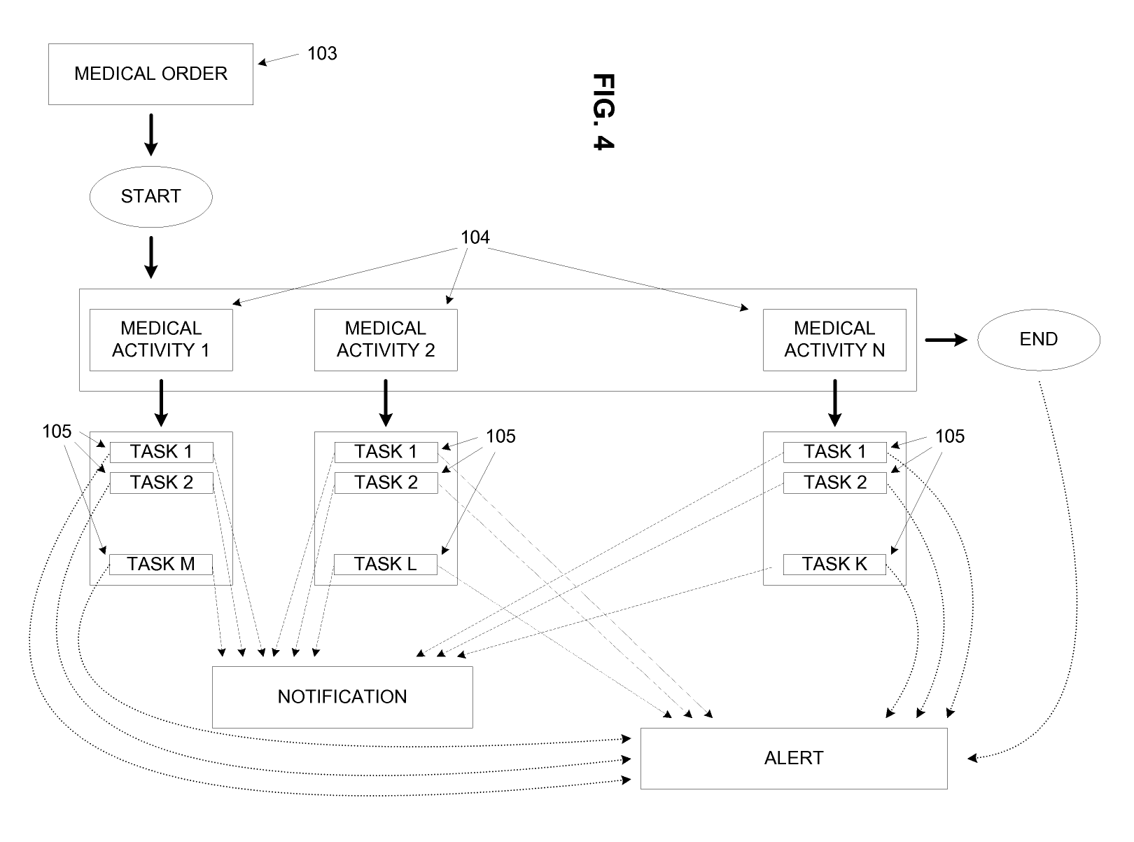

Reference is now made to FIG. 4 which is a schematic illustration presenting notifications and alerts associated with an exemplary medical order work flow, according to some embodiment of the present invention. The medical order 103 is initiated and split to one or more medical activities 104. The one or more medical activities 104 are each further divided to a plurality of tasks 105 and each task 105 is associated with one or more of the care providers 101. For each task 105 the system 200 transmits a notification to the accountable one or more of the care providers 101. During the execution of the plurality of tasks 105, the system 200 may transmit a plurality of alerts to the accountable one or more of the care providers according to the task rules defined in the system 200, for example, start of task execution, completion of task execution and/or incompletion of task execution within a pre-defined time period.

According to some embodiments of the present invention, there are provided a system 200 that manages and monitors a medical order, the system 200 receives the medical order 103, automatically generates a list of medical activities 104 required to perform the medical order 103, associates the medical activities 104 with relevant one or more of the care providers 101, notifies the relevant one or more of the care providers 101 of the medical activities 104, tracks the progress of the medical order 103, alerts the relevant one or more of the care providers 101 of events in the medical order 103 and logs the medical order 103.

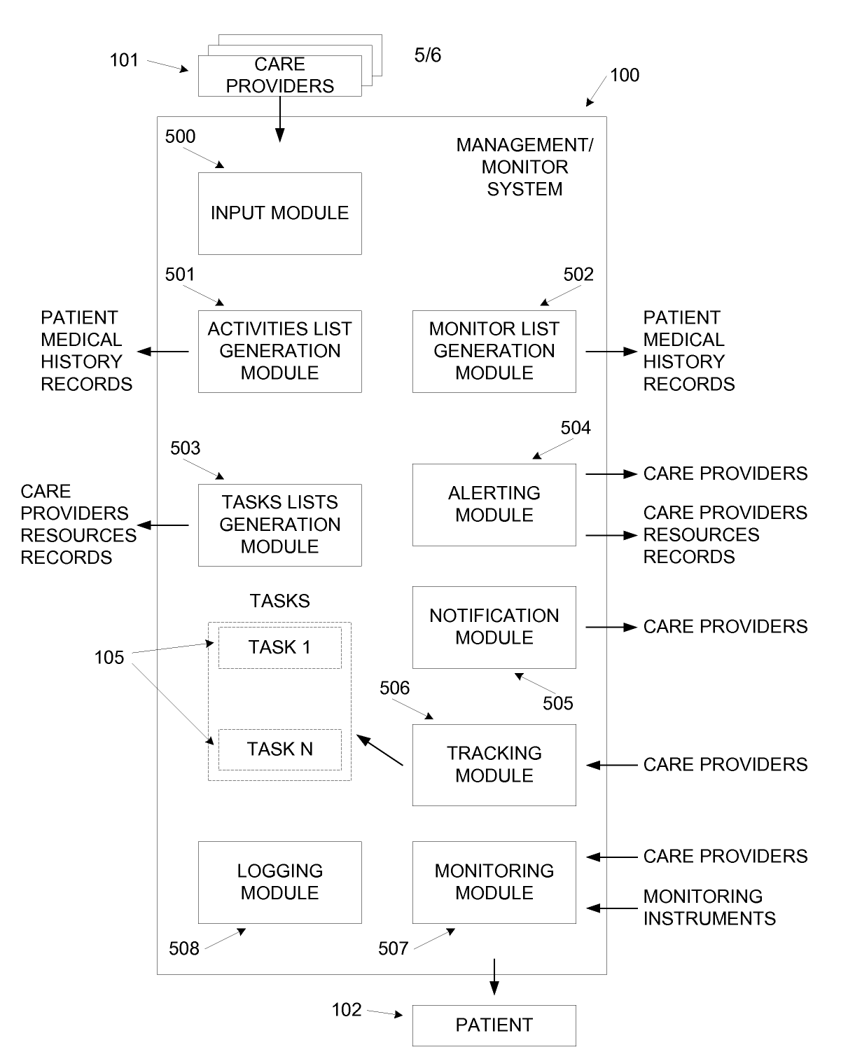

Reference is now made to FIG. 5 which is a schematic illustration of modules included in an exemplary system for managing a medical order, according to some embodiment of the present invention.

An input module 500 receives the medical order 103 that is issued by one or more of the care providers 101 using the plurality of client terminals. The received medical order 103 is forwarded to an activities list generation unit 501 and a monitor list generation unit 502.

The activities list generation module 501 splits the medical order 103 into one or more medical activities 104 according to a pre-defined template that includes the medical activities 104 that are required for the medical order 103.

The monitor list generation module 502 generates a monitor list according to a pre-defined template that includes the monitoring information required for the medical order 103 with respect to the patient 102. The monitor list may include a plurality of conditional monitor rules that may be used for alerting one or more of the care providers 101 in the event a condition is fulfilled.

A tasks lists generation module 503 further divides the activities list to a plurality of singular tasks 105 according to a pre-defined template that includes the tasks 105 that are required for each activity 104. The plurality of tasks 105 are initiated and maintained in the system 200. The tasks lists generation module 503 associates each of the plurality of tasks 105 with an accountable one or more of the care providers 101. The tasks lists generation module 503 transfers the information of each of the plurality of tasks 105 and the information of the one or more of the care providers 101 associated with task 105 to a notification module 505.

The notification module 505 transmits a notification message over the one or more networks to one or more of the care providers 101 using the plurality of client terminals. The notification message includes the information of the one or more of the care providers 101 that are assigned with the task 105.

A monitoring module 507 monitors the monitoring information for the patient 102 as dictated by the monitor list that is generated by the monitor list generation module 502. The plurality of tasks 105 are continuously tracked by a tracking module 506. The tracking module 506 holds an accurate status for each of the plurality of tasks 105. In case a condition is fulfilled for one or more of the monitor rules, the monitoring module 507 transfers the condition information to an alert module 304. In case a condition is fulfilled for one or more of the task rules, the tracking module 506 transfers the condition information to the alert module 304.

The alert module 304 transmits an alert message over the one or more networks to one or more of the care providers 101 using the plurality of client terminals. The alert message is transmitted according to a pre-defined list of care providers 101 and includes the information on the monitor rule and/or task(s) rule conditions that are identified.

The logging module 508 logs the tracking status information for the plurality of tasks 105 and/or monitoring information that is collected during the workflow of the medical order 103. The logged information may be available to one or more of the care providers 101 using the plurality of client terminals during and after the time of execution of the medical order 103.

Optionally, the tasks lists generation module 503 accesses the resources records 210 to retrieve the accountable one or more of the care providers 101 that are available to perform the task 105 according to a plurality of availability parameters, for example, expertise, responsibility and/or location. The tasks lists generation module 503 may retrieve contact information for the accountable one or more of the care providers 101.

More optionally, the monitoring module 507 receives monitoring information of the patient 102 from a plurality of medical monitoring instruments 230 that are capable of transmitting monitoring information using the one or more networks.

More optionally, the monitoring module 507 receives monitoring information of the patient 102 from one or more of the care providers 101 using the plurality of client terminals using the one or more networks.

More optionally, the monitoring module 507 receives monitoring information of the patient 102 from the patient 102 using the plurality of client terminal using the one or more networks.

More optionally, the monitoring module 507 makes the monitoring information of the patient 102 available to one or more of the care providers 101 using the plurality of client terminals using the one or more networks.

More optionally, the tracking module 506 makes the status information for each one of the plurality of tasks 105 available to one or more of the care providers 101 using the plurality of client terminals using the one or more networks.

More optionally, the alerting module 304 accesses the resources records 210 to retrieve the accountable one or more of the care providers 101 that are available to receive the alert according to a plurality of availability parameters. The alerting module 304 may retrieve contact information for the accountable one or more of the care providers 101.

Some embodiments of the present invention, are presented herein by means of an example, however the use of this example does not limit the scope of the present invention in any way. The example presents a workflow of the medical order 103 in an exemplary medical environment employing a system 200 for managing the medical order 103.

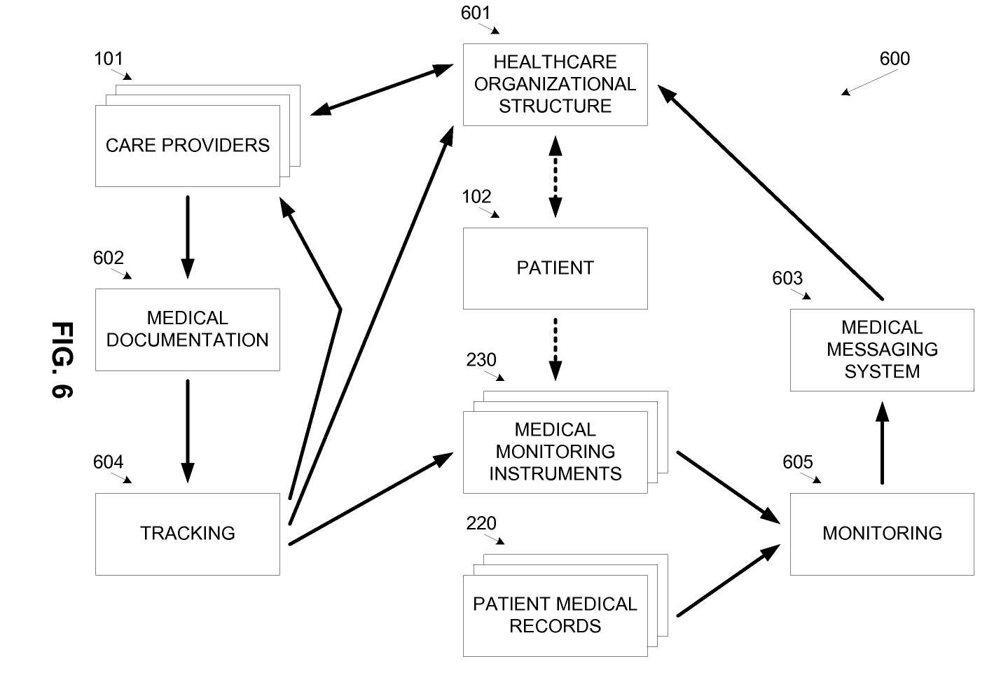

Reference is now made to FIG. 6 which is a workflow of a medical order in an exemplary medical environment implementing a system for managing a medical order, according to some embodiment of the present invention. A medical environment 600 employs a system that maintains closed loop control with feedback for performing medical activities, for example, treatments and/or procedures provided to the patient 102. The medical environment 600 includes the plurality of care providers 101, a healthcare organizational structure 601, the plurality of medical monitoring instruments 230, the plurality of patient medical records 220, a monitoring unit 605, a medical messaging unit 603, a tracking unit 604 and a medical documentation system 602 all focused on the patient 102.

The monitoring unit 605 which may employ the monitoring module 507 and/or the monitor list generation unit 502 of the system 100 collects monitoring information with respect to the patient 102. The monitoring information may be collected from the plurality of medical monitoring instruments 230 that are monitoring the patient 102, from one or more of the care providers 102 that are attending the patient 102 and/or from the patient 102. The plurality of monitoring instruments 230 may be mobile or stationary, and the monitoring information the plurality of monitoring instruments 230 produce may be automatically transmitted by the monitoring instruments 230 using the one or more networks, reported by one or more of the plurality of care providers 101 using the plurality of client terminals and/or be reported by the patient 102 using the plurality of client terminal. The monitoring unit 605 automatically generates a monitor list (watch list) according to a pre-define template that dictates the monitoring information required with respect to the medical order 103 for the patient 102. The monitor list also includes condition rules for generating an alert message in the event of a medical situation identified through the monitor list condition rules. The monitor list condition rules may include escalation rules to identify an escalation in the condition of the patient 102 and generate an escalation event. The monitor list may be modified by one or more of the care providers 101 to adapt to the condition of the patient 102. The monitoring unit 605 may access the plurality of patient medical records 220 located at a plurality of locations and present in a plurality of formats for retrieving medical history of the patient 102 and use it for providing a complete medical view of the patient 102. The patient medical records 220 may further include the plurality of EMR systems. The medical history of the patient 102 may be used to interpret monitoring information and/or manipulate monitoring requirements and monitor list for the patient 102. The monitoring information may include events identified by the monitor list condition rules, for example, escalation in the condition of the patient 102. The monitoring unit 605 forwards the collected monitoring information to the medical messaging unit 603.

The medical messaging unit 603 may include the task lists generation module 503, the notification module 505 and/or the alerting module 504. The medical messaging unit 603 associates the plurality of tasks 105 with one or more of the plurality of care providers 101, where the plurality of tasks 105 are required by the medical activities 104 which are derived from the medical order 103. The medical messaging unit 603 informs the accountable one or more of the plurality of the care providers 101 when attention is needed to the patient 102. The medical messaging unit 603 may handle escalation in the condition of the patient 102 as reported by the monitoring unit 605. In the event of escalation one or more messages may be transmitted to one or more of the care providers 101 to raise attention to the escalation situation. The medical messaging unit 603 may access the healthcare organizational structure 601 for retrieving availability of the one or more of the care providers 101 from the resources records 210. The availability information for the plurality of the care providers 101 allows the medical messaging unit 603 to dynamically identify a suitable accountable one or more of the care providers 101 in real time. Availability information parameters may include for example expertise, ranking in the healthcare organization and/or location of treatment.

The tracking unit 604 which is the final unit in the workflow of the medical order within the medical environment 600 performs tracking on the tasks related to the medical order 103. The tracking unit 604 may employ the activities list generation module 501, the tasks lists generation module 503, the tracking module 506 and/or the alerting module 504. The tracking unit 604 tracks the progress of the plurality of tasks 105 that are initiated with respect to the medical activities 104 associated with the medical order 103. The tracking unit 604 may access the healthcare organizational structure 601 for retrieving availability of the one or more of the care providers 101 from the resources records 210. The availability information for the plurality of the care providers 101 allows the tracking unit 604 to dynamically identify an accountable one or more of the care providers 101 in real time. Availability information parameters may include for example expertise, ranking in the healthcare organization and/or location of treatment. The tracking unit 604 is coupled with the medical messaging unit 603 for transmitting alert messages to the accountable one or more of the care providers 101 with respect to status of the plurality of tasks 105 and/or with respect to the condition of the patient 102 as reported through the monitoring information.

The documentation unit 602 logs the workflow of the medical order 103 and stores the generated information, for example, status and progression of the plurality of tasks 105 and/or monitoring information of the patient 102. The documentation unit 602 may employ the logging module 508. The stored log data may be used for long and short term uses, for example, to be recorded in the medical history record of the patient 102 and/or to be inserted back into the workflow of the medical order 103 to initiate additional medical activities that may be required according to the condition of the patient 102.

The terms “client terminal” relates to any device and/or apparatus which may be used for input and/or output of data thorough a human interface, for example desktop computer, laptop, tablet, telephone, mobile phone and/or beeper. The term “human interface” relates to any form of human-machine interface for example, keyboard, touch screen, microphone, speaker and/or motion sensor.

What is claimed is:

1. A method for managing a plurality of medical orders issued for a plurality of patients, comprising:
receiving a medical order that defines a plurality of medical activities to be performed in a predefined workflow for a medical treatment provided to a patient;
automatically creating a list of a plurality of tasks for each of said plurality of medical activities, each said task is assigned with a tracking status;
automatically associating each of said plurality of tasks with at least one of a plurality of care providers;
automatically notifying said at least one care provider using a plurality of client terminals about respective said associated task;
aggregating a plurality of input messages each indicative of a status of one of said plurality of tasks;
automatically updating said tracking status according to said plurality of input messages during a period between said receiving and a completion of said medical order; and
outputting a dataset of said medical order which is indicative of said tracking status for each said task.

2. The method of claim 1, wherein said receiving is from said at least one care provider using said plurality of client terminals.

3. The method of claim 1, wherein said notifying includes transmitting at least one notification message to said at least one care provider using said plurality of client terminals.

4. The method of claim 1, wherein said tracking status includes a plurality of condition rules.

5. The method of claim 1, further comprising automatically alerting said at least one care provider when at least one of a plurality of condition rules is fulfilled, wherein said plurality of condition rules are included in said tracking status.

6. The method of claim 5, wherein said alerting includes transmitting at least one alert message to said at least one care provider using said plurality of client terminals.

7. The method of claim 1, further comprising automatically creating a list of monitoring information of said patient that is required for said medical order.

8. The method of claim 7, further comprising said list of monitoring information includes a plurality of monitor rules to identify levels of escalation in the condition of said patient according to the contents of said monitoring information.

9. The method of claim 1, further comprising retrieving at least one of a plurality of medical history records of said patient from a plurality of databases.

10. The method of claim 9, further comprising said plurality of databases is available in a plurality of storage formats.

11. The method of claim 1, further comprising said list of tasks is modified by at least one of said plurality of care providers.

12. The method of claim 7, further comprising said list of monitoring information is automatically modified with respect to at least one of a plurality of medical history records of said patient, wherein said plurality of medical history records are retrieved from a plurality of databases.

13. The method of claim 1, further comprising said plurality of input messages are received from at least one of said plurality of care providers using a plurality of client terminals.

14. The method of claim 1, further comprising said plurality of input messages include monitoring information on the condition of said patient.

15. The method of claim 1, further comprising said plurality of input messages are received from a plurality of medical monitoring instruments.

16. The method of claim 1, further comprising said plurality of input messages are received from said patient using a plurality of client terminals.

17. The method of claim 1, further comprising said plurality of care providers using said plurality of client terminals have access to said tracking status of said plurality of tasks.

18. The method of claim 14, further comprising said plurality of care providers using said plurality of client terminals have access to said monitoring information of said patient.

19. The method of claim 9, further comprising said plurality of care providers using said plurality of client terminals have access to said medical history of said patient.

20. The method of claim 1, further comprising accessing a plurality of resource systems of said plurality of care providers and identifying an availability of said plurality of care providers in real time.

21. The method of claim 20, further comprising said associating is done according to said availability.

22. The method of claim 5, further comprising said alerting is done according to availability of said care providers, wherein said availability is identified in real time by accessing a plurality of resource systems of said plurality of care providers.

23. The method of claim 5, further comprising said alerting includes alerting at least one another of said plurality of care providers in the event of escalation according to a plurality of condition rules, wherein said plurality of condition rules are included in said tracking status.

24. The method of claim 5, further comprising said alerting includes alerting at least one another of said plurality of care providers in the event of escalation in the condition of said patient according to a plurality of monitor rules, wherein said plurality of monitor rules are included in a list of monitoring information that is automatically created.

25. The method of claim 1, wherein said completion is selected from a group consisting of: completion of said plurality of tasks, termination of said medical order, postponement of said medical order.

26. A system for managing a plurality of medical orders issued for a plurality of patients, comprising:
an input module which receives a medical order from at least one of a plurality of care providers using a plurality of client terminals;
an activities list generation module which generates an activities list that defines a plurality of medical activities to be performed in a predefined workflow for a medical treatment provided to a patient;
a tasks list generation module which automatically creates a list of a plurality of tasks for each of said plurality of medical activities, assigns a tracking status to each of said plurality of tasks and associates each of said plurality of tasks with said at least one of care provider;
a notification module which automatically transmits a notification message over a plurality of networks to said at least one care provider using said plurality of client terminals about respective said associated task;
a tracking module which aggregates a plurality of input messages each indicative of a status of one of said plurality of tasks and automatically updates said tracking status according to said plurality of input messages; and
a log module which holds a plurality of information records of the said workflow of said medical order.

27. The system of claim 26, wherein said tracking status includes a plurality of condition rules.

28. The system of claim 26, further comprises an alert module which automatically transmits an alert message over said plurality of networks to said at least one care provider using said plurality of client terminals when at least one of a plurality of condition rules is fulfilled, wherein said plurality of condition rules are included in said tracking status.

29. The system of claim 26, further comprises a monitor list generation module which automatically creates a list of monitoring information of said patient that is required for said medical order.

30. The system of claim 26, further comprising said tasks list generation module is capable of retrieving at least one of a plurality of medical history records of said patient from a plurality of databases.

31. The system of claim 26, further comprising said plurality of input messages are received from at least one of said plurality of care providers using a plurality of client terminals.

32. The system of claim 26, further comprising said plurality of input messages include monitoring information on the condition of said patient.

33. The system of claim 26, further comprising said plurality of input messages are received from a plurality of medical monitoring instruments.

34. The system of claim 26, further comprising said tasks list generation unit is capable of accessing a plurality of resource systems of said plurality of care providers to identify availability of said plurality of care providers in real time.
